(19) United States
(12) Patent Application Publication
(10) Pub. No.: US 2025/0035932 A1
(43) Pub. Date: Jan. 30, 2025

(54) WEARABLE ELECTRONIC DEVICE INCLUDING TRANSPARENT DISPLAY

(71) Applicant: Samsung Electronics Co., Ltd., Suwon-si (KR)

(72) Inventors: Chanhyung YOO, Suwon-si (KR); Byungkwon KANG, Suwon-si (KR); Kwangtai KIM, Suwon-si (KR); Hyunsoo KIM, Suwon-si (KR); Hongsuk KIM, Suwon-si (KR); Soonsang PARK, Suwon-si (KR); Dongchoon HWANG, Suwon-si (KR)

(21) Appl. No.: 18/787,467

(22) Filed: Jul. 29, 2024

Related U.S. Application Data
(63) Continuation of application No. PCT/KR2024/011055, filed on Jul. 29, 2024.

(30) Foreign Application Priority Data
Jul. 28, 2023 (KR) 10-2023-0098743
Oct. 20, 2023 (KR) 10-2023-0141084

(51) Int. Cl. G02B 27/01

(52) U.S. Cl. CPC G02B 27/0172; G02B 2027/014; G02B 2027/0178

(57) ABSTRACT

According to an embodiment of the disclosure, a wearable electronic device may be provided. The wearable electronic device may comprise a display member and a light output device including a polarizer. The display member may include a first lens, a second lens configured to transmit light of a first polarization state and refract light of a second polarization state, an optical waveguide disposed between the first lens and the second lens and configured to receive light output from the light output device and emit the light of the first polarization state toward the second lens, and a transparent display assembly including a transparent display disposed between the first lens and the optical waveguide and configured to output the light of the second polarization state toward the second lens.

### CROSS-REFERENCE TO RELATED APPLICATIONS

This application is a continuation of International Application No. PCT/KR2024/011055 designating the United States, filed on Jul. 29, 2024, in the Korean Intellectual Property Receiving Office and claiming priority to Korean Patent Application Nos. 10-2023-0098743, filed on Jul. 28, 2023, and 10-2023-0141084, filed on Oct. 20, 2023, in the Korean Intellectual Property Office, the disclosures of each of which are incorporated by reference herein in their entireties.

### BACKGROUND

### Field

The disclosure relates to a wearable electronic device including a transparent display.

### Description of Related Art

Portable electronic devices, such as electronic schedulers, portable multimedia players, mobile communication terminals, or tablet PCs, are generally equipped with a display member and a battery, and come in bar, clamshell, or slidable shape by the shape of the display member or battery. As display members and batteries are nowadays made smaller and have enhanced performance, wearable electronic device which may be put on the user's wrist, head, or other body portions are commercially available. Wearable electronic devices may be directly worn on the human body, presenting better portability and user accessibility.

Wearable electronic devices may include electronic devices wearable on the user's face, such as head-mounted devices (HMDs). The head-mounted device may be usefully used to implement virtual reality or augmented reality. For example, the wearable electronic device may stereoscopically provide the image of the virtual space in the game played on TV or computer monitor and may implement virtual reality by blocking the real-world image. Other types of wearable electronic devices may implement virtual images while providing an environment in which the real-world image of the space where the user actually stays may be visually perceived, thereby providing augmented reality to provide various pieces of visual information to the user.

The above-described information may be provided as related art for the purpose of helping understanding of the disclosure. No claim or determination is made as to whether any of the foregoing is applicable as background art in relation to the disclosure.

### SUMMARY

According to an example embodiment of the disclosure, a wearable electronic device may be provided. The wearable electronic device may comprise: a display member and a light output device. The display member may include: a first lens, a second lens configured to transmit light of a first polarization state and refract light of a second polarization state, an optical waveguide disposed between the first lens and the second lens and configured to receive light output from the light output device and emit the light of the first polarization state toward the second lens, and a transparent display assembly including a transparent display disposed between the first lens and the optical waveguide and configured to output the light of the second polarization state toward the second lens.

According to an example embodiment, a wearable electronic device may be provided. The wearable electronic device may comprise: a display member and a light output device. The display member may include: a first lens, a second lens, an optical waveguide disposed between the first lens and the second lens and configured to receive light output from the light output device and emit the light of the first polarization state toward the second lens, and a transparent display assembly including a transparent display disposed between the first lens and the optical waveguide and configured to output light toward the second lens. The wearable electronic device may be configured to be manually or automatically switchable between a first mode in which the transparent display assembly is deactivated and a second mode in which the transparent display assembly is activated.

### BRIEF DESCRIPTION OF THE DRAWINGS

The foregoing and other aspects, features, and/or advantages of an embodiment of the present disclosure will be more apparent from the following detailed description, taken in conjunction with the accompanying drawings, in which:

FIG. 1 is a block diagram illustrating an example electronic device in a network environment according to an embodiment of the disclosure.

FIG. 2 is a perspective view illustrating a wearable electronic device according to an embodiment of the disclosure.

FIG. 3 is a perspective view illustrating a wearable electronic device according to an embodiment of the disclosure.

FIG. 4 is an exploded perspective view illustrating a wearable electronic device according to an embodiment of the disclosure.

FIG. 5 is a perspective view illustrating an example optical structure of a display member and an optical output device of a wearable electronic device according to an embodiment.

FIG. 6 is a diagram illustrating a side view of an optical structure of a display member of a wearable electronic device according to an embodiment.

FIG. 7 is a graph illustrating a diffraction angle for each diffraction order according to a display panel pixel size.

FIG. 8 is a flowchart illustrating an example operation of activating a transparent display assembly of a wearable electronic device according to an embodiment.

FIG. 9 is a diagram illustrating a side view of an optical structure of a display member of a wearable electronic device according to an embodiment.

FIG. 10 is a diagram illustrating a side view of an optical structure of a display member of a wearable electronic device according to an embodiment.

FIG. 11 is a perspective view illustrating an example optical structure of a display member and an optical output device of a wearable electronic device according to an embodiment.

FIG. 12 is a perspective view illustrating an example optical structure of a display member and an optical output device of a wearable electronic device according to an embodiment.

FIG. 13A is a front perspective view illustrating an example wearable electronic device according to an embodiment of the disclosure; and

FIG. 13B is a rear perspective view illustrating an example wearable electronic device according to an embodiment of the disclosure.

Throughout the drawings, like reference numerals may be assigned to like parts, components, and/or structures.

### DETAILED DESCRIPTION

The following description taken in conjunction with the accompanying drawings is provided to aid a comprehensive understanding of various embodiments of the disclosure. The following description may include various specific details to aid understanding, but these may be considered examples. Hence, it should be appreciated by one of ordinary skill in the art that various changes or modifications may be made to the various embodiments without departing from the spirit or scope of the present disclosure. Descriptions of well-known functions and configurations may be omitted for clarity and conciseness.

The terms and words used in the following description and claims are not limited to the dictionary meaning, but are used by the inventors to enable a clear and consistent understanding of the disclosure. Accordingly, it will be apparent to one of ordinary skill in the art that the following description of various example embodiments of the disclosure is provided by way of example only and not to limit the disclosure including the appended claims and equivalents thereof.

As used herein, the singular forms “a,” “an,” and “the” are intended to include the plural forms as well, unless the context clearly indicates otherwise. For example, when a “surface” of a component is mentioned, it may refer, for example, to one or more of surfaces of the component.

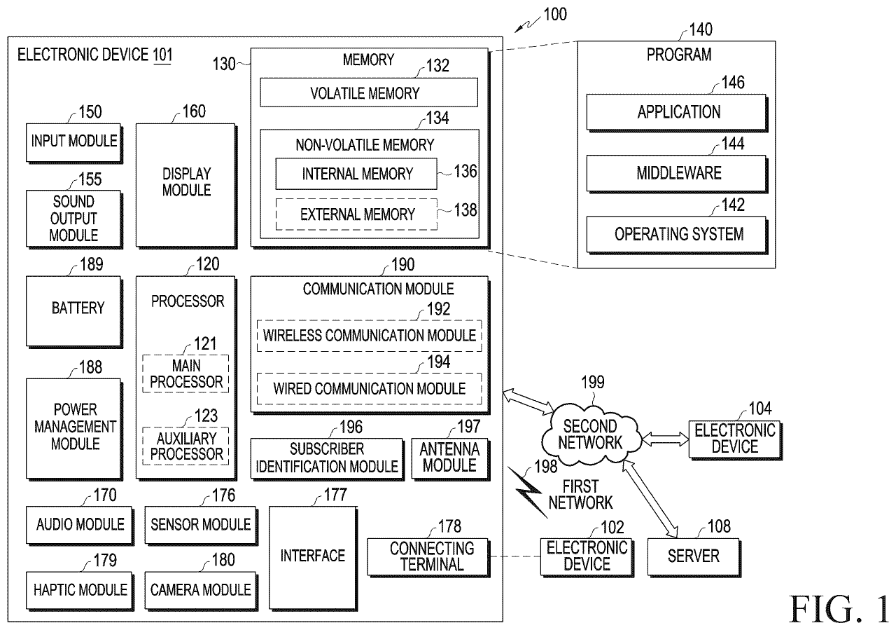

FIG. 1 is a block diagram illustrating an example electronic device in a network environment according to an embodiment of the disclosure.

Referring to FIG. 1, the electronic device (or wearable electronic device) in the network environment 100 may communicate with an external electronic device 102 via a first network 198 (e.g., a short-range wireless communication network), or an external electronic device 104 or a server 108 via a second network 199 (e.g., a long-range wireless communication network). According to an embodiment, the electronic device 101 may communicate with the external electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a second sensor module configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

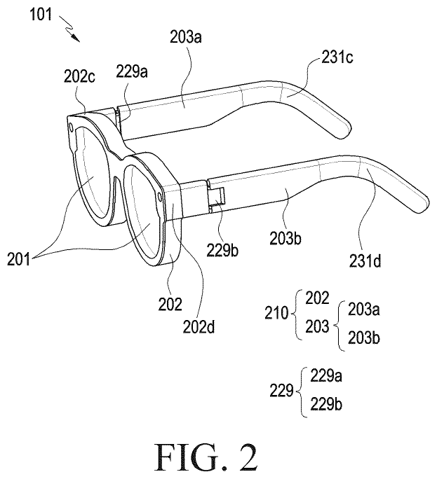

FIG. 2 is a perspective view illustrating an example wearable electronic device according to an embodiment of the disclosure. The configuration of the wearable electronic device 101 of FIG. 2 may be identical in whole or part to the configuration of the electronic device 101 of FIG. 1.

Referring to FIG. 2, the wearable electronic device 101 may include an electronic device of a type (e.g., glasses type) that may be worn on the user's body (e.g., head). For example, the user may visually recognize ambient things or environment while wearing the wearable electronic device 101. For example, the wearable electronic device 101 may include a head-mounted device (HMD) or smart glasses capable of providing images directly in front of the user's eyes.

According to an embodiment, the wearable electronic device 101 may include a housing that forms the exterior of the wearable electronic device 101. The housing 210 may provide a space in which components of the wearable electronic device 101 may be disposed. For example, the housing 210 may include a lens frame 202 and at least one wearing member 203.

According to an embodiment, the wearable electronic device 101 may include a display member 201 disposed in the housing 210 and capable of outputting a visual image. For example, the wearable electronic device 101 may include at least one display member 201 capable of providing the user with visual information (or images). For example, the display member 201 may include a module equipped with a lens, a display, a waveguide (or optical waveguide), and/or a touch circuit. According to an embodiment, the display member 201 may be transparent or semi-transparent. According to an embodiment, the display member 201 may include a semi-transparent glass or a window member the light transmittance of which may be adjusted as the coloring concentration is adjusted.

According to an embodiment, the lens frame 202 may receive at least a portion of the display member 201. For example, the lens frame 202 may surround at least a portion of the display member 201. According to an embodiment, the lens frame 202 may position at least one of the display members 201 to correspond to the user's eye. According to an embodiment, the lens frame 202 may include the rim of a normal eyeglass structure. According to an embodiment, the lens frame 202 may include at least one closed loop surrounding the display devices 201. According to an embodiment, the lens frame 202 may include a first end 202c and a second end 202d disposed opposite to the first end 202c. The first end 202c may be disposed adjacent to the first wearing member 203a, and the second end 202d may be disposed adjacent to the second wearing member 203b.

According to an embodiment, the wearing members 203 may extend from the lens frame 202. For example, the wearing members 203 may extend from ends 202c and 202d of the lens frame 202 and, together with the lens frame 202, may be supported and/or positioned on a part (e.g., ears) of the user's body. According to an embodiment, the wearing members 203 may be rotatably coupled to the lens frame 202 through hinge structures 229. According to an embodiment, the wearing member 203 may include a first surface 231c configured to face the user's body and a second surface 231d opposite to the first surface 231c. According to an embodiment (not shown), at least a portion of the wearing member 203 may be formed of a flexible material (e.g., rubber). For example, at least a portion of the wearing member 203 may be formed in a band shape surrounding at least a portion of the user's body (e.g., ears).

According to an embodiment, the wearable electronic device 101 may include the hinge structures 229 configured to fold the wearing members 203 on the lens frame 202. The hinge structure 229 may be disposed between the lens frame 202 and the wearing member 203. While the user does not wear the wearable electronic device 101, the user may fold the wearing members 203 on the lens frame 202 to carry or store the electronic device. According to an embodiment, the hinge structure 229 may include a first hinge structure 229a connected to a portion (e.g., the first end 202c) of the lens frame 202 and the first wearing member 203a and a second hinge structure 229b connected to a portion (e.g., the second end 202d) of the lens frame 202 and the second wearing member 203b.

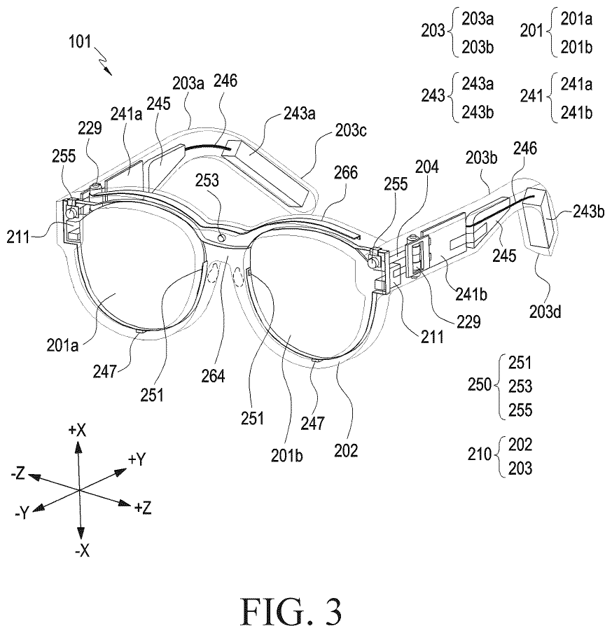

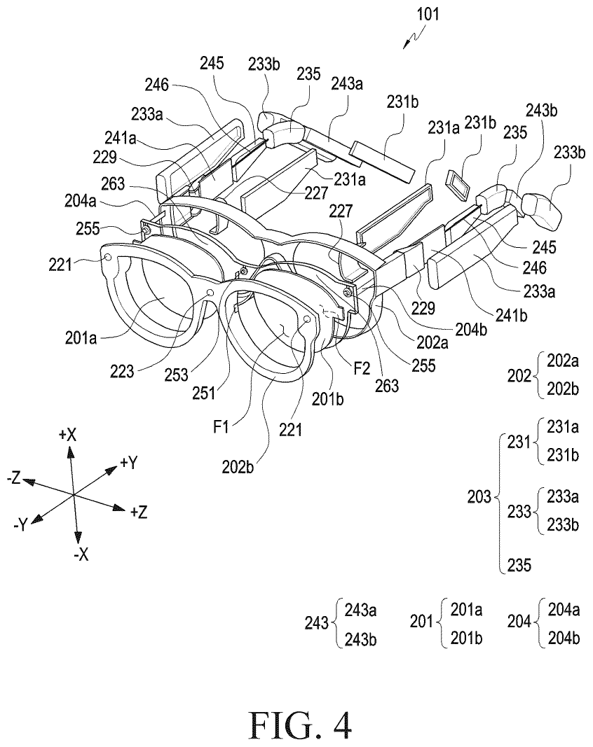

FIG. 3 is a perspective view illustrating an example wearable electronic device 101 according to an embodiment of the disclosure. FIG. 4 is an exploded perspective view illustrating an example wearable electronic device 101 according to an embodiment.

The configuration of the display member 201, the lens frame 202, the wearing member 203, and the hinge structure 229 of FIGS. 3 and/or 4 may be identical in whole or part to the configuration of the display member 201, the lens frame 202, the wearing member 203, and the hinge structure 229 of FIG. 2.

Referring to FIGS. 3 and 4, the wearable electronic device 101 may include at least one display member 201, a lens frame 202, at least one wearing member 203, at least one hinge structure 229, at least one circuit board 241, at least one battery 243, at least one power transfer structure 246, at least one camera module 250, and/or at least one sensor module.

According to an embodiment, the wearable electronic device 101 may obtain and/or recognize a visual image regarding an object or environment in the direction (e.g., −Y direction) in which the wearable electronic device 101 faces or the direction in which the user gazes, using the camera module 250 (e.g., the camera module 180 of FIG. 1) and may receive information regarding the object or environment from an external electronic device (e.g., the external electronic device 102 or 104 of FIG. 1 or the server 108 of FIG. 1) through a network (e.g., the first network 198 or second network 199 of FIG. 1). In an embodiment, the wearable electronic device 101 may provide the received object- or environment-related information, in the form of an audio or visual form, to the user. The wearable electronic device 101 may provide the received object- or environment-related information, in a visual form, to the user through the display members 201, using the display module (e.g., the display module 160 of FIG. 1). For example, the wearable electronic device 101 may implement augmented reality (AR) by implementing the object- or environment-related information in a visual form and combining it with an actual image of the user's surrounding environment.

According to an embodiment, a pair of display members 201 may be provided and disposed to correspond to the user's left and right eyes, respectively, with the wearable electronic device 101 worn on the user's body. For example, the display member 201 may include a first display member 201a and a second display member 201b disposed to be spaced apart from the first display member 201a. The first display member 201a may be disposed to correspond to the user's right eye, and the second display member 201b may be disposed to correspond to the user's left eye.

According to an embodiment, the display member 201 may include a first surface F1 facing in a direction (e.g., −y direction) in which external light is incident and a second surface F2 facing in a direction (e.g., +y direction) opposite to the first surface F1. With the user wearing the wearable electronic device 101, at least a portion of the light or image coming through the first surface F1 may be incident on the user's left eye and/or right eye through the second surface F2 of the display member 201 disposed to face the user's left eye and/or right eye.

According to an embodiment, the lens frame 202 may include at least two or more frames. For example, the lens frame 202 may include a first frame 202a and a second frame 202b. According to an embodiment, when the user wears the wearable electronic device 101, the first frame 202a may be a frame of the portion facing the user's face, and the second frame 202b may include a portion of the lens frame 202 spaced from the first frame 202a in the gazing direction (e.g., −Y direction) in which the user gazes.

According to an embodiment, the electronic device 101 may include at least one light output module 211 configured to provide an image and/or video to the user. For example, the light output module 211 may include a display panel capable of outputting images and a collimating lens corresponding to the user's eye and guiding images to the display member 201. For example, the user may obtain the image output from the display panel of the light output module 211 through the collimating lens of the light output module 211. According to an embodiment, the light output module 211 may include a device configured to display various information. For example, the light output module 211 may include at least one of a liquid crystal display (LCD), a digital mirror device (DMD), a liquid crystal on silicon (LCoS), a light emitting diode (LED on silicon (LEDoS), an organic light emitting diode (OLED), a micro light emitting diode (micro LED), or a laser scanning projector. According to an embodiment, when the light output module 211 and/or the display member 201 includes one of a liquid crystal display device, a digital mirror display device, or a silicon liquid crystal display device, the wearable electronic device 101 may include a light output module 211 and/or a light source emitting light to the display area of the display member 201. According to an embodiment, when the light output module 211 and/or the display member 201 includes organic light emitting diodes or micro LEDs, the wearable electronic device 101 may provide virtual images to the user without a separate light source.

According to an embodiment, at least a portion of the light output module 211 may be disposed in the housing 210. For example, the light output module 211 may be connected to the display member 201 and may provide images to the user through the display member 201. For example, the image output from the light output module 211 may be incident on the display member 201 through an input optical member positioned at an end of the display member 201 and be radiated to the user's eyes through a waveguide and an output optical member positioned in at least a portion of the display member 201.

According to an embodiment, the wearable electronic device 101 may include a circuit board 241 (e.g., a printed circuit board (PCB), a printed board assembly (PBA), a flexible PCB (FPCB), or a rigid-flexible PCB (RFPCB)) receiving components for driving the wearable electronic device 101. For example, the circuit board 241 may include at least one integrated circuit chip, and at least one of a processor (e.g., the processor 120 of FIG. 1), memory (e.g., the memory 130 of FIG. 1), a power management module (e.g., the power management module 188 of FIG. 1), or a communication module (e.g., the communication module 190 of FIG. 1) may be provided in the integrated circuit chip. According to an embodiment, a circuit board 241 may be disposed in the wearing member 203 of the housing 210. For example, the circuit board 241 may include a first circuit board 241a disposed in the first wearing member 203a and a second circuit board 241b disposed in the second wearing member 203b. According to an embodiment, the communication module (e.g., the communication module 190 of FIG. 1) may be mounted on the first circuit board 241a positioned in the first wearing member 203a, and the processor (e.g., the processor 120 of FIG. 1) may be mounted on the second circuit board 241b positioned in the second wearing member 203b. According to an embodiment, the circuit board 241 may be electrically connected to the battery 243 (e.g., the battery 189 of FIG. 1) through the power transfer structure 246. According to an embodiment, the circuit board 241 may include an interposer board.

According to an embodiment, the battery 243 may be connected with components (e.g., the light output module 211, the circuit board 241, and the speaker module 245, the microphone module 247, and/or the camera module 250) of the wearable electronic device 101 and may supply power to the components of the wearable electronic device 101.

According to an embodiment, at least a portion of the battery 243 may be disposed in the wearing member 203. According to an embodiment, the battery 243 may include a first battery 243a disposed in the first wearing member 203a and a second battery 243b disposed in the second wearing member 203b. According to an embodiment, batteries 243 may be disposed adjacent to ends 203c and 203d of the wearing members 203.

According to an embodiment, the speaker module 245 (e.g., the audio module 170 or the sound output module 155 of FIG. 1) may convert an electrical signal into sound. At least a portion of the speaker module 245 may be disposed in the wearing member 203 of the housing 210. According to an embodiment, the speaker module 245 may be located in the wearing member 203 to correspond to the user's ear. According to an embodiment (e.g., FIG. 3), the speaker module 245 may be disposed next to the circuit board 241. For example, the speaker module 245 may be disposed between the circuit board 241 and the battery 243. According to an embodiment (not shown), the speaker module 245 may be disposed on the circuit board 241. For example, the speaker module 245 may be disposed between the circuit board 241 and the inner case (e.g., the inner case 231 of FIG. 4).

According to an embodiment, the wearable electronic device 101 may include a power transfer structure 246 configured to transfer power from the battery 243 to an electronic component (e.g., the light output module 211) of the wearable electronic device 101. For example, the power transfer structure 246 may be electrically connected to the battery 243 and/or the circuit board 241, and the circuit board 241 may transfer the power received through the power transfer structure 246 to the light output module 211. According to an embodiment, the power transfer structure 246 may include a component capable of transferring power. For example, the power transfer structure 246 may include a flexible printed circuit board or wiring. For example, the wiring may include a plurality of cables (not shown). In an embodiment, various changes may be made to the shape of the power transfer structure 246 considering the number and/or type of the cables.

According to an embodiment, the microphone module 247 (e.g., the input module 150 and/or the audio module 170 of FIG. 1) may convert a sound into an electrical signal. According to an embodiment, the microphone module 247 may be disposed in the lens frame 202. For example, at least one microphone module 247 may be disposed on a lower end (e.g., in the −X-axis direction) and/or on an upper end (e.g., in the +X-axis direction) of the wearable electronic device 101. According to an embodiment, the wearable electronic device 101 may more clearly recognize the user's voice using voice information (e.g., sound) obtained by the at least one microphone module 247. For example, the wearable electronic device 101 may distinguish the voice information from the ambient noise based on the obtained voice information and/or additional information (e.g., low-frequency vibration of the user's skin and bones). For example, the wearable electronic device 101 may clearly recognize the user's voice and may perform a function of reducing ambient noise (e.g., noise canceling).

According to an embodiment, the camera module 250 may capture a still image and/or a video. The camera module 250 may include at least one of a lens, at least one image sensor, an image signal processor, or a flash. According to an embodiment, the camera module 250 may be disposed in the lens frame 202 and may be disposed around the display member 201.

According to an embodiment, the camera module 250 may include at least one first camera module 251. According to an embodiment, the first camera module 251 may capture the trajectory of the user's eye (e.g., a pupil) or gaze. For example, the first camera module 251 may capture the reflection pattern of the light emitted by the light emitting unit (e.g., the light output module 211 of FIG. 3) to the user's eyes. For example, the light emitting unit (e.g., the light output module 211 of FIG. 3) may emit light of an infrared wavelength for tracking the trajectory of the gaze using the first camera module 251. For example, the light emitting unit (e.g., the light output module 211 of FIG. 3) may include an IR LED. According to an embodiment, the processor (e.g., the processor 120 of FIG. 1) may adjust the position of the virtual image so that the virtual image projected on the display member 201 corresponds to the direction in which the user's eye (e.g., pupil) gazes. According to an embodiment, it is possible to track the trajectory of the user's eyes or gaze using a plurality of first camera modules 251 having the same specifications and performance.

According to an embodiment, the camera modules 250 may include at least one second camera module 253. According to an embodiment, the second camera module 253 may capture an external image. According to an embodiment, the second camera module 253 may capture an external image through the second optical hole 223 formed in the second frame 202b. For example, the second camera module 253 may include a high-resolution color camera, and it may include a high resolution (HR) or photo video (PV) camera. According to an embodiment, the second camera module 253 may provide an auto-focus (AF) function and an image stabilization first (e.g., an optical image stabilizer (EIS), digital image stabilization (DIS), or electrical image stabilization (EIS)).

According to an embodiment, the wearable electronic device 101 may include a flash (not shown) positioned adjacent to the second camera module 253. For example, the flash may provide light for increasing brightness (e.g., illuminance) around the wearable electronic device 101 when an external image is obtained by the second camera module 253, thereby reducing difficulty in obtaining an image due to the dark environment, the mixing of various light beams, and/or the reflection of light.

According to an embodiment, the camera modules 250 may include at least one third camera module 255. According to an embodiment, the third camera module 255 may capture the user's motion through a first optical hole 221 formed in the lens frame 202. For example, the third camera module 255 may capture the user's gesture (e.g., hand gesture). Third camera modules 255 and/or first optical holes 221 may be disposed on two opposite sides of the lens frame 202 (e.g., the second frame 202b), e.g., formed in two opposite ends of the lens frame 202 (e.g., the second frame 202b) with respect to the Z direction. According to an embodiment, the third camera module 255 may include a global shutter (GS)-type camera. For example, the third camera module 255 may be a camera supporting 3DoF (degrees of freedom) or 6DoF, which may provide position recognition and/or motion recognition in a 360-degree space (e.g., omni-directionally). According to an embodiment, the third camera modules 255 may be stereo cameras and may perform the functions of simultaneous localization and mapping (SLAM) and user motion recognition using a plurality of global shutter-type cameras with the same specifications and performance. According to an embodiment, the third camera module 255 may include an infrared (IR) camera (e.g., a time of flight (TOF) camera or a structured light camera). For example, the IR camera may be operated as at least a portion of a sensor module (e.g., the sensor module 176 of FIG. 1) for detecting a distance from the subject.

According to an embodiment, at least one of the first camera module 251 or the third camera module 255 may be replaced with a sensor module (e.g., the sensor module 176 of FIG. 1). For example, the sensor module may include at least one of a vertical cavity surface emitting laser (VCSEL), an infrared sensor, and/or a photodiode. For example, the photodiode may include a positive intrinsic negative (PIN) photodiode or an avalanche photodiode (APD). The photodiode may be interpreted as a photo detector or a photo sensor.

According to an embodiment, at least one of the first camera module 251, the second camera module 253, and the third camera module 255 may include a plurality of camera modules (not shown). For example, the second camera module 253 may include a plurality of lenses (e.g., wide-angle and telephoto lenses) and image sensors and may be disposed on one surface (e.g., a surface facing in the −Y axis) of the electronic device 101. For example, the wearable electronic device 101 may include a plurality of camera modules having different properties (e.g., angle of view) or functions and control to change the angle of view of the camera module based on the user's selection and/or trajectory information. At least one of the plurality of camera modules may include a wide-angle camera and at least another of the plurality of camera modules may form a telephoto camera.

According to an embodiment, the processor (e.g., processor 120 of FIG. 1) may determine the motion of the wearable electronic device 101 and/or the user's motion using information for the wearable electronic device 101 obtained using at least one of a gesture sensor, a gyro sensor, or an acceleration sensor of the sensor module (e.g., the sensor module 176 of FIG. 1) and the user's action (e.g., approach of the user's body to the wearable electronic device 101) obtained using the third camera module 255. According to an embodiment, in addition to the above-described sensor, the wearable electronic device 101 may include a magnetic (geomagnetic) sensor capable of measuring an orientation using a magnetic field and magnetic force lines and/or a hall sensor capable of obtaining motion information (e.g., moving direction or distance) using the strength of a magnetic field. For example, the processor may determine the motion of the electronic device 101 and/or the user's motion based on information obtained from the magnetic (geomagnetic) sensor and/or the hall sensor.

According to an embodiment (not shown), the wearable electronic device 101 may perform an input function (e.g., a touch and/or pressure sensing function) capable of interacting with the user. For example, a component configured to perform a touch and/or pressure sensing function (e.g., a touch sensor and/or a second sensor module) may be disposed in at least a portion of the wearing member 203. The wearable electronic device 101 may control the virtual image output through the display member 201 based on the information obtained through the components. For example, a sensor associated with a touch and/or pressure sensing function may be implemented in various types, e.g., a resistive type, a capacitive type, an electro-magnetic (EM) type, or an optical type. According to an embodiment, the component configured to perform the touch and/or pressure sensing function may be identical in whole or part to the configuration of the input module 150 of FIG. 1.

According to an embodiment, the wearable electronic device 101 may including a reinforcing member 266 that is disposed in an inner space of the lens frame 202 and formed to have a higher rigidity than that of the lens frame 202.

Referring to FIG. 4, according to an embodiment, the electronic device 101 may include a lens structure 263. The lens structure 263 may refract at least a portion of light. For example, the lens structure 263 may include a prescription lens having a designated refractive power. According to an embodiment, at least a portion of the lens structure 263 may be disposed behind (e.g., +Y direction) of the display member 201. For example, the lens structure 263 may be positioned between the display member 201 and the user's eye.

According to an embodiment, the housing 210 may include a hinge cover 227 that may conceal a portion of the hinge structure 229. For example, another part of the hinge structure 229 may be received or hidden between an inner cover 231 and an outer cover 233, which are described below.

According to an embodiment, the wearing member 203 may include the inner cover 231 and the outer cover 233. For example, the inner cover 231 may be, e.g., a cover configured to face the user's body or directly contact the user's body, and may be formed of a material having low thermal conductivity, e.g., a synthetic resin. According to an embodiment, the inner cover 231 may include a first surface (e.g., the first surface 231c of FIG. 2) facing the user's body. For example, the outer cover 233 may include, e.g., a material (e.g., a metal) capable of at least partially transferring heat and may be coupled to the inner cover 231 to face each other. According to an embodiment, the outer cover 233 may include a second surface (e.g., the second surface 231d of FIG. 2) opposite to the first surface 231c. In an embodiment, at least one of the circuit board 241 or the speaker module 245 may be received in a space separated from the battery 243 in the wearing member 203. In the illustrated embodiment, the inner cover 231 may include a first cover 231a receiving the circuit board 241 and/or the speaker module 245 and a second cover 231b receiving the battery 243, and the outer cover 233 may include a third cover 233a coupled to face the first cover 231a and a fourth cover 233b coupled to face the second cover 231b. For example, the first cover 231a and the third cover 233a may be coupled (hereinafter, ‘first cover portions 231a and 233a’) to receive the circuit board 241 and/or the speaker module 245, and the second cover 231b and the fourth cover 233b may be coupled (hereinafter, ‘second cover portions 231b and 233b’) to receive the battery 343.

According to an embodiment, the first cover portions 231a and 233a may be rotatably coupled to the lens frame 202 through the hinge structure 229, and the second cover portions 231b and 233b may be connected or mounted to the ends of the first cover portions 231a and 233a through the connecting structure 235. According to an embodiment, a portion of the connecting structure 235 in contact with the user's body may be formed of a material having low thermal conductivity, e.g., an elastic material, such as silicone, polyurethane, or rubber, and another portion thereof which does not come into contact with the user's body may be formed of a material having high thermal conductivity (e.g., a metal). For example, when heat is generated from the circuit board 241 or the battery 243, the connecting structure 235 may reduce heat transfer to the portion in contact with the user's body while dissipating or discharging heat through the portion not in contact with the user's body. According to an embodiment, a portion of the connecting structure 235 configured to come into contact with the user's body may be interpreted as a portion of the inner cover 231, and a portion of the connecting structure 235 that does not come into contact with the user's body may be interpreted as a portion of the outer cover 233. According to an embodiment (not shown), the first cover 231a and the second cover 231b may be integrally configured without the connecting structure 235, and the third cover 233a and the fourth cover 233b may be integrally configured without the connecting structure 235. According to an embodiment, other components (e.g., the antenna module 197 of FIG. 1) may be further included in addition to the illustrated components, and information regarding an object or environment may be received from an external electronic device (e.g., the electronic device 102 or 104 of FIG. 1 or the server 108 of FIG. 1) through a network (e.g., the first network 198 or second network 199 of FIG. 1) using a communication module (e.g., the communication module 190 of FIG. 1).

According to an embodiment, the lens frame 202 may include a connection portion 264 disposed between the first display member 201a and the second display member 201b and connecting the two display members 201a and 201b. For example, the connection portion 264 may be interpreted as a portion corresponding to the nose support of the glasses.

According to an embodiment, the electronic device 101 may include a connection member 204. According to an embodiment, the circuit board 241 may be connected to the connection member 204 and transfer electrical signals to the components of the electronic device 101 (e.g., the light output module 211 and/or the camera module 250) through the connection member 204. For example, the control signal transferred from a processor (e.g., the processor 120 of FIG. 1) positioned on the circuit board 241 may be transferred to electronic components by at least a portion of the connection member 204. For example, at least a portion of the connection member 204 may include a line (not shown) electrically connected to components of the electronic device 101.

According to an embodiment, the connection member 204 may include a first connection member 204a at least partially disposed in the first wearing member 203a and/or a second connection member 204b at least partially disposed in the second wearing member 203b. According to an embodiment, at least a portion of the first connection member 204a and/or the second connection member 204b may face the hinge structure 229. For example, the first connection member 204a may extend from the first circuit board 241a to the inside of the lens frame 202 across the hinge structure 229. The second connection member 204b may extend from the second circuit board 241b to the inside of the lens frame 202 across the hinge structure 229. For example, a portion of the first connection member 204a and a portion of the second connection member 204b may be disposed in the wearing member 203, and another portion may be disposed in the lens frame 202.

According to an embodiment, the first connection member 204a and/or the second connection member 204b may include a structure that may be folded or unfolded based on rotation of the hinge structure 229. For example, the first connection member 204a and/or the second connection member 204b may include a flexible printed circuit board (FPCB). According to an embodiment, the first connection member 204a may be electrically and/or mechanically connected to the first circuit board 241a. According to an embodiment, the second connection member 204b may be electrically and/or mechanically connected to the second circuit board 241b. According to an embodiment, the first connection member 204a and/or the second connection member 204b may include a structure (e.g., a line and/or cable) for transferring signals.

According to an embodiment, the sensor module (not shown) (e.g., the sensor module 176 of FIG. 1) may detect the light that has passed through the display member 201. According to an embodiment, the sensor module (not shown) may include a first sensor module (not shown) capable of detecting the light passed through the first display member 201a and a second sensor module (not shown) capable detecting the light passed through the second display member 201b. For example, the first sensor module (not shown) may detect light from behind the first display member 201a (e.g., +Y direction), and the second sensor module (not shown) may detect light from behind the second display member 201b. According to an embodiment, the sensor module (not shown) may include a third sensor module (not shown) capable of detecting light in front of the display member 201 (e.g., −Y direction). For example, the third sensor module (not shown) may detect light in front of the display member 201 (e.g., −Y direction). According to an embodiment, the sensor module (not shown) may include an illuminance sensor. According to an embodiment, the third sensor module (not shown) may have the same configuration in whole or part as the configuration of the second camera module 253.

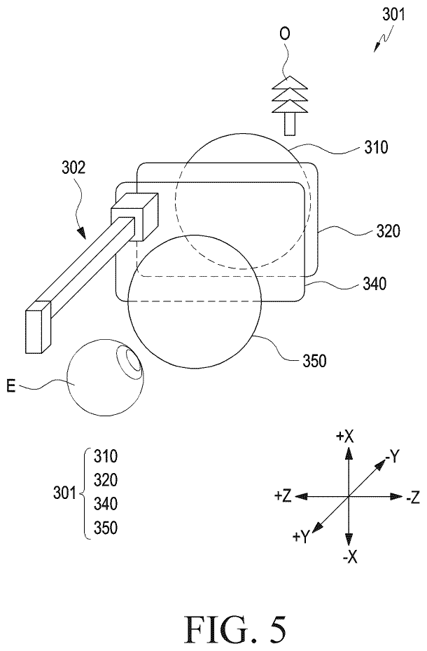

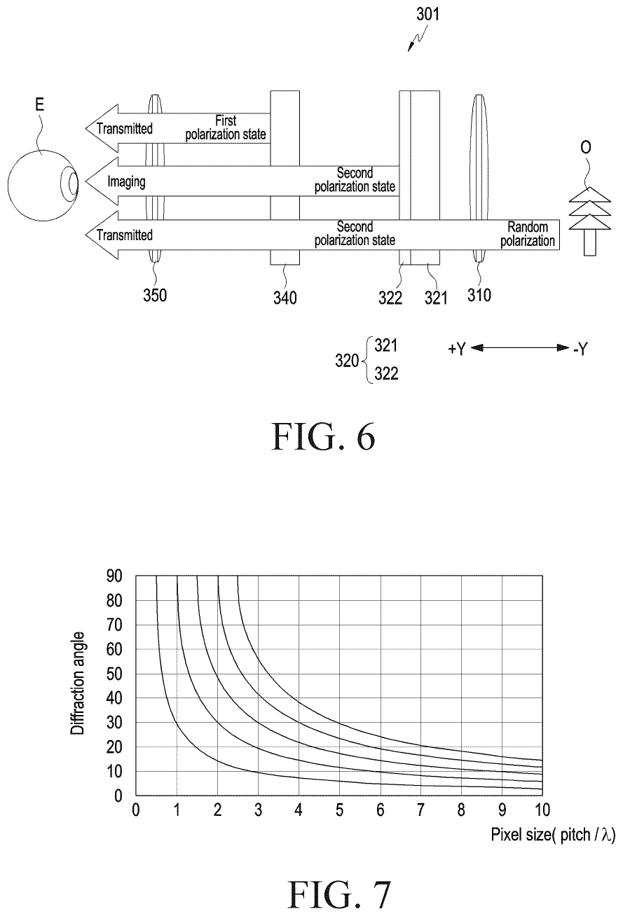

FIG. 5 is a perspective view illustrating an example optical structure of a display member and an optical output device of a wearable electronic device according to an embodiment. FIG. 6 is a diagram illustrating a side view of an optical structure of a display member of a wearable electronic device according to an embodiment. FIG. 7 is a graph illustrating a diffraction angle for each diffraction order according to a display panel pixel size.

The display member 301 of FIGS. 5 and 6 may be applied to the wearable electronic device 101 of FIGS. 1, 2, 3 and 4 (which may be referred to as FIGS. 1 to 4). The configuration of the display member 301 of FIGS. 5 and 6 may be identical or similar in whole or part to the configuration of the light output module 211 of FIG. 3.

In an embodiment, a wearable electronic device (e.g., the wearable electronic device 101 of FIGS. 1 to 4) may include a display member 301 (e.g., the display member 201 of FIGS. 2 to 4) and a light output device 302 (e.g., the light output module 211 of FIG. 3). For example, the wearable electronic device 101 may be smart glasses or a head-mounted device (HMD).

According to an embodiment, the display member 301 may include a correction lens or distortion compensation lens 310, a polarization dependent lens 350, a transparent display assembly 320, and/or an optical waveguide 340. As is described below, according to an embodiment, the wearable electronic device 101 may be configured to be manually or automatically switchable between a first mode in which the transparent display assembly 320 is deactivated and a second mode in which the transparent display assembly 320 is activated. According to an embodiment, in the second mode in which the transparent display assembly 320 is activated, the display member 301 may be configured to provide an image in which a first image (e.g., a virtual image or an augmented image) based on light emitted from the optical waveguide 340 and a second image based on light emitted from the transparent display assembly 320 overlap. For example, the second image based on the light emitted from the transparent display assembly 320 may provide additional information to the first image (e.g., a virtual image or an augmented image) or may provide a high luminance, high dynamic range (HDR), light field image for enhancing luminance or image quality of the first image.

According to an embodiment, the light output device 302 may include a display panel capable of outputting light (or an image). According to an embodiment, the light output device 302 may be configured to output light (or an image) of a specific polarization state (e.g., a first polarization state) to the optical waveguide 340 of the display member 301. For example, the light output device 302 may include a polarizer or a polarization control element. According to an embodiment, the light output device 302 may be configured to output light (or an image) to the optical waveguide 340 of the display member 301 in a random polarization state.

According to an embodiment, the display member 301 may include a first surface (e.g., the first surface F1 of FIG. 4) (e.g., the surface in the −Y direction) facing an external object O of the wearable electronic device (e.g., the wearable electronic device 101 of FIGS. 1 to 4) and a second surface (e.g., the second surface F2 of FIG. 4) facing in a direction opposite to the first surface. For example, the second surface F2 may be disposed to face the user's left eye and/or right eye while the user wears the wearable electronic device 101. According to an embodiment, the correction lens 310 may be disposed closer to the first surface F1 than the second surface F2 of the display member 301. As an example, a lens surface (e.g., a lens surface in the −Y direction) of the correction lens 310 may form at least a portion of the first surface F1 of the display member 301. According to an embodiment, the polarization dependent lens 350 may be disposed closer to the second surface F2 than the first surface F1 of the display member 301. As an example, the lens surface (e.g., the lens surface in the +Y direction) of the polarization dependent lens 350 may form at least a portion of the second surface F2 of the display member 301.

According to an embodiment, the correction lens 310 may be disposed to receive light from the outside of the wearable electronic device 101 and transfer the light toward the polarization dependent lens 350. According to an embodiment, the polarization dependent lens 350 may be disposed to face the left eye and/or the right eye of the user. According to an embodiment, the polarization dependent lens 350 may be configured to transmit light in the first polarization state as it is and to refract light in the second polarization state.

According to an embodiment, the correction lens 310 may correct a real object (real scene) O distorted by the polarization dependent lens 350. For example, when the correction lens 310 is omitted, the light reflected from the real object O may be polarized in the second polarization state by the display assembly 320 in the random polarization state, and may be provided to the user as a distorted (e.g., enlarged) image as compared to the image of the real object O by the polarization dependent lens 350 that selectively functions as a lens (e.g., convex lens) for the light in the second polarization state. According to an embodiment, the polarization dependent lens 350 may selectively have positive refractive power for light in the second polarization state. In this case, the correction lens 310 may have negative refractive power for optically cancelling distortion caused by the polarization dependent lens 350. According to an embodiment, the correction lens 310 may help to deliver the real object O to the user without distortion. For example, the refractive power (negative refractive power) of the correction lens 310 may be changed by parameters such as the refractive power of the polarization dependent lens 350 and the separation distance between the correction lens 310 and the polarization dependent lens 350. For example, in the disclosure, the “second polarization state” may include a polarization component perpendicular to any “first polarization state”. For example, the “first polarization state” may refer, for example, to horizontal polarization, and the “second polarization state” may refer, for example, to vertical polarization, and vice versa.

According to an embodiment, the transparent display assembly 320 may be disposed between the correction lens 310 and the optical waveguide 340 and may be configured to output light in the second polarization state toward the polarization dependent lens 350. In an embodiment, the transparent display assembly 320 may include a transparent display (or a transparent display panel) 321. In the disclosure, “light emitted from the transparent display assembly 320” may be referred to as “a second image provided from the transparent display assembly 320” or “a second image based on light emitted from the transparent display assembly 320”.

According to an embodiment, the transparent display 321 may be substantially transparent. For example, the transparent display 321 may include a transparent organic light emitting diode or a transparent light emitting diode. Further, the transparent display 321 may include, for example, and without limitation, at least one of a liquid crystal display (LCD), a digital mirror device (DMD), a liquid crystal on silicon (LCoS), a light emitting diode (LED) on silicon (LEDoS), laser scanning projector, or the like. For example, the transparent display 321 may include a transparent screen and a projection display.

In an embodiment, the transparent display assembly 320 may further include a polarizer 322 disposed on one surface of the transparent display 321. According to an embodiment, the polarizer 322 may be disposed on a surface (e.g., the surface in the +Y direction) of the transparent display 321 facing the polarization dependent lens 350. The polarizer 322 may be configured to receive light (or an image) output from the transparent display 321 and emit the light in the second polarized state.

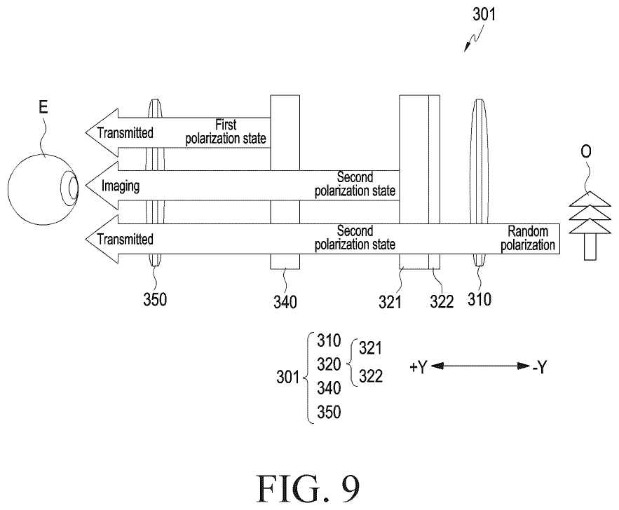

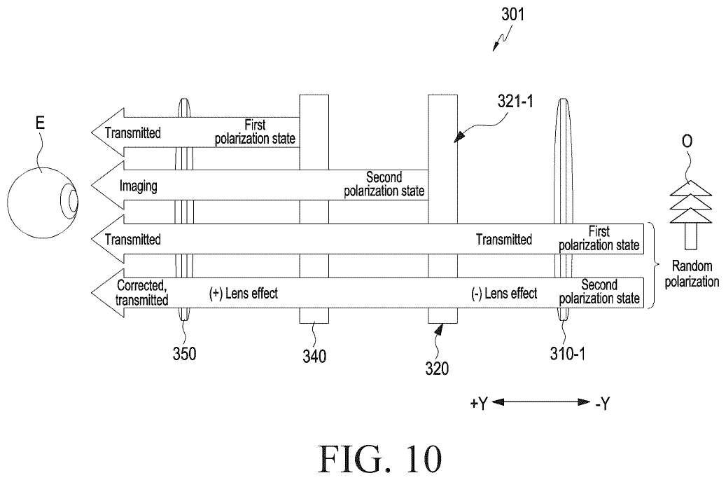

In the disclosure, the placement of the polarizer 322 may be changed (see FIG. 9), and the polarizer 322 may be omitted from the transparent display assembly 320 (see FIG. 10). According to an embodiment, the light (or image) output from the transparent display assembly 320 and the light (or image) emitted from the optical waveguide 340 may require the same refractive power (or focal plane) adjustment, and in this case, the polarizer 322 may be omitted. In this case, the display member 301 may have an optical structure disposed in a general lens order replacing the correction lens 310, the transparent display assembly 320, the optical waveguide 340, and the polarization dependent lens 350.

According to an embodiment, the optical waveguide 340 may be disposed between the correction lens 310 and the polarization dependent lens 350. According to an embodiment, the optical waveguide 340 may be configured to receive light (or an image) output from the optical output device 302 and emit the light toward the polarization dependent lens 350. In the disclosure, the polarization state of the light emitted from the optical waveguide 340 may be changed. In the disclosure, “light emitted from the optical waveguide 340” may be referred to as “a first image provided from the optical waveguide 340” or “a first image based on light emitted from the optical waveguide 340”. For example, the optical waveguide 340 may include an input terminal to which light output from the optical output device 302 is incident and an output terminal to emit light toward the polarization dependent lens 350. According to an embodiment, the optical waveguide 340 may be configured to receive light from the optical output device 302 and emit the light in the first polarization state toward the polarization dependent lens 350. According to an embodiment, the optical waveguide 340 may receive light output in the first polarization state from the optical output device 302 and emit the light in the first polarization state. According to an embodiment, the optical waveguide 340 may be configured to receive light output in the random polarization state from the optical output device 302, polarize the light in a first polarized state, and emit the light. For example, among the light in the random polarization state output from the light output device 302, only the light in the first polarized state may be selectively received through the input terminal of the optical waveguide 340, and the light in the first polarized state may be emitted to the output terminal of the optical waveguide 340.

In the disclosure, the polarization characteristic or the polarization state of light emitted from the optical waveguide 340 may be changed. According to an embodiment, the light (or image) output from the transparent display assembly 320 and the light (or image) emitted from the optical waveguide 340 may require the same refractive power (or focal plane) adjustment. In this case, the optical waveguide 340 may be configured to receive the light from the optical output device 302 and emit the light in the second polarization state toward the polarization dependent lens 350. According to an embodiment, the optical waveguide 340 may receive light output in the second polarization state from the optical output device 302 and emit the light in the second polarization state. For example, among the light in the random polarization state output from the light output device 302, only the light in the second polarized state may be selectively received through the input terminal of the optical waveguide 340, and the light in the second polarized state may be emitted to the output terminal of the optical waveguide 340. According to an embodiment, the optical waveguide 340 may be configured to receive light output in the random polarization state from the optical output device 302, polarize the light in a second polarized state, and emit the polarized light.

According to an embodiment, the optical waveguide 340 may be formed to be substantially transparent. For example, the optical waveguide 340 may include glass or polymer. According to an embodiment, the external light of the wearable electronic device 101 received through the correction lens 310 and the light (or image) output from the transparent display assembly 320 may be transmitted through the optical waveguide 340 without entering the optical waveguide 340 or the input terminal of the optical waveguide 340. For example, the optical waveguide 340 may be configured as a free-form prism, and the incident light may be provided to the user through a reflective element (e.g., a reflective mirror). For example, the optical waveguide 340 may include a nano pattern formed on one inner or outer surface, e.g., a grating structure having a polygonal or curved shape.

According to an embodiment, the optical waveguide 340 may include at least one diffractive element such as a diffractive optical element (DOE), a holographic optical element (HOE), or a reflective element (e.g., a reflective mirror). For example, the optical waveguide 340 may guide light emitted from the optical output device 302 to the user's eye E using at least one diffractive element or reflective element. For example, the diffractive element of the optical waveguide 340 may include an input grating area and an output grating area. The input grating area may serve as an input terminal for diffracting (or reflecting) light output from the light output device 302 to be transferred into the optical waveguide 340. The output grating area may serve as an output terminal for diffracting (or reflecting) light transferred through the inside of the optical waveguide 340 to the user's eye E. In an embodiment, the reflective element of the optical waveguide 340 may include a total reflection optical element or a total reflection waveguide for total internal reflection (TIR). For example, total reflection is one method of inducing light, and may refer, for example, to an incident angle being created so that light (e.g., a virtual image or an augmented image) incident on the input terminal of the optical waveguide 340 or the input grating area is 100% reflected from one surface (e.g., a specific surface) of the waveguide 340, and is 100% transferred to the output terminal of the optical waveguide 340 or the output grating area.

According to an embodiment, the image (or light) of the real object, introduced from the outside of the wearable electronic device (e.g., the wearable electronic device 101 of FIGS. 1 to 4) may pass through the transparent display 321. When the image of the real object (e.g., the real object O of FIGS. 5 and 6) passes through the pixel opening (or aperture), which is the transmission area disposed in individual pixels of the transparent display 321, a diffraction effect may occur in the image of the real object O according to the size of the aperture, and thus the image quality of the real object O may be deteriorated. FIG. 7 may show the diffraction angle according to each diffraction order, according to the pixel size of the transparent display (or transparent display panel) 321 of the transparent display assembly 320. In FIG. 7, the horizontal axis may represent the pixel size (e.g., the pixel pitch) (pitch/λ), and the vertical axis may represent the diffraction angle. The graphs of FIG. 7 may show the relationship between the pixel size and the diffraction angle at different diffraction orders. The graphs positioned on the right side in FIG. 7 may have a relatively large diffraction order. Referring to FIG. 7, it may be identified that, e.g., as the pixel size increases at the same diffraction order, the diffraction angle decreases and, conversely, as the pixel size decreases at the same diffraction order, the diffraction angle increases. According to an embodiment, in order to provide the image of the real object O at a high resolution, the pixel size of the transparent display 321 may be set to be about 6 to 7 times the wavelength having little or no effect of diffraction. For example, the pixel size of the transparent display 321 may be about 7 μm or more and the pixel density may be 1200 PPI.

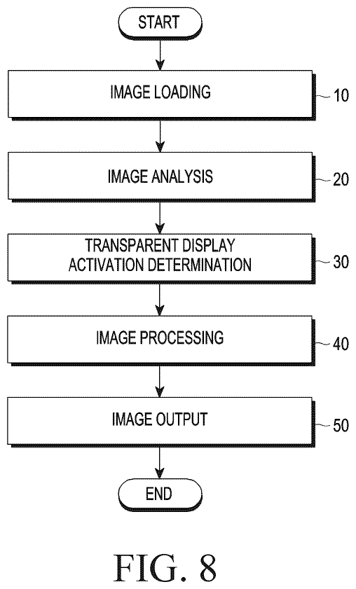

FIG. 8 is a flowchart illustrating an example operation of activating a transparent display assembly of a wearable electronic device according to an embodiment.

FIG. 8 may illustrate an operation in which the transparent display assembly 320 of the display member 301 of FIGS. 5 and 6 is activated. According to an embodiment, a wearable electronic device (e.g., the wearable electronic device 101 of FIGS. 1 to 4) may be configured to be manually and/or automatically switchable between a first mode in which the transparent display assembly 320 is deactivated and a second mode in which the transparent display assembly 320 is activated. According to an embodiment, the wearable electronic device 101 provides the first image to the optical waveguide as default and may additionally provide the second image that is output from the transparent display assembly 320, for an image required to be provided as a high-luminance, high dynamic range (HDR) image. The second image may provide additional information to the first image (e.g., a virtual image or an augmented image) provided from the optical waveguide 340 or may provide a high luminance, HDR, and/or light field image for enhancing luminance or image quality of the first image. For example, the transparent display assembly 320 may be provided as a light field display or a dual display for providing a 3D image together with, or regardless of, a function of supplementing the first image provided by the optical waveguide 340 with a high luminance or HDR image.

According to an embodiment, the processor (e.g., the processor 120 of FIG. 1) of the wearable electronic device 101 may be configured to automatically switch from the first mode in which the transparent display assembly 320 is deactivated to the second mode in which the transparent display assembly 320 is activated by analyzing the first image (e.g., a virtual image or an augmented image) provided through the optical waveguide 340.

Referring to FIG. 8, there may be included an operation 10 (or image loading of FIG. 8) of loading the first image provided from the optical waveguide 340, an operation 20 (or image analysis of FIG. 8) of analyzing the first image, an operation 30 (or transparent display (321) activation determination of FIG. 8) of determining whether the transparent display assembly 320 (e.g., the transparent display 321) is activated, an operation 40 (or image processing of FIG. 8) of processing the second image and/or the first image provided from the transparent display assembly 320, and an operation 50 (or image output of FIG. 8) of outputting the first image and/or the second image. For example, the image analysis 20, the transparent display activation determination 30, the image processing 40, and/or the image output 50 may be performed by an application (AP) operator (e.g., a graphic processing unit (GPU) or a deep learning processor (DPU)) of a processor (e.g., the processor 120 of FIG. 1). When the user manually switches the mode between the first mode in which the transparent display assembly 320 is deactivated and the second mode in which the transparent display assembly 320 is activated, the image analysis 20, the image processing 40, and the image output 50 may be performed in the second mode, except for the transparent display activation determination (30) operation.

According to an embodiment, in operation 20 of analyzing the first image provided by the optical waveguide 340, the processor (e.g., the processor 120 of FIG. 1) may analyze the first image (e.g., a virtual image or an augmented image) and may store information about the first image as a parameter. For example, the information about the first image stored as the parameter may be various pieces of information including luminance, the number of objects belonging to the first image that need to be supplemented to implement the HDR image, the area ratio of the object, the location (e.g., the coordinate system value) of the object, and the implementation level (e.g., the brightness contrast ratio of the corresponding object to the average brightness of the first image).

According to an embodiment, in the operation 30 of determining whether the transparent display assembly 320 (e.g., the transparent display 321) is activated, the processor (e.g., the processor 120 of FIG. 1) may compare the parameter stored in the operation 10 of loading the first image with a pre-stored specific threshold (e.g., the number of objects, the area ratio of the object, and the brightness contrast ratio) to determine whether the transparent display assembly 320 operates. For example, the comparison between the parameter for the first image and the specific threshold and the determination of whether the transparent display operates may be programmed in an image rendering pipeline and performed in real time. For example, it may be determined whether the transparent display assembly 320 operates by comparing the parameter for the first image with the specific threshold using a preset table. For example, when the user manually switches the mode between the first mode in which the transparent display assembly 320 is deactivated and the second mode in which the transparent display assembly 320 is activated, the image analysis 20 may also be deactivated in the first mode.

According to an embodiment, in the operation 40 (or the image processing of FIG. 8) of processing the second image and/or the first image, the processor 120 (e.g., the application operator) may create split images of the first image and the second image to be loaded on the light output device 302 and the display assembly 320, respectively, may perform image processing for optimization on each split image, and may transmit image information to a display operator (display unit (DPU)) of the processor 120. According to an embodiment, in operation 50 of outputting the first image and/or the second image, the light output device 302 and the display assembly 320 may output each of the first image and the second image based on the image information received from the display calculator.

According to an embodiment, the transparent display assembly 320 may be configured to be settable to a low power mode or an always-on display (AOD) mode. According to an embodiment, a function in which the optical waveguide 340 provides a high-resolution image (e.g., a virtual image or an augmented image) in the low-power mode or the AOD mode may be deactivated, and only a function in which the transparent display assembly 320 provides a low-resolution image (e.g., a virtual image or an augmented image) may be activated.

According to an embodiment, the transparent display 321 of the transparent display assembly 320 may have a transmittance adjusting element (e.g., a dimming element) disposed on a surface of the wearable electronic device (e.g., the wearable electronic device 101 of FIGS. 1 to 4) facing the external real object 0. The transmittance adjusting element may be configured to adjust the transmittance to enhance visibility according to the brightness of the image of the real object O. For example, the transmittance of the transmittance adjusting element may be adjusted to 0 to 100%, and as an example, when the transmittance is 0, the wearable electronic device 101 may be utilized as smart glasses (e.g., a VR device) that provides a virtual image.

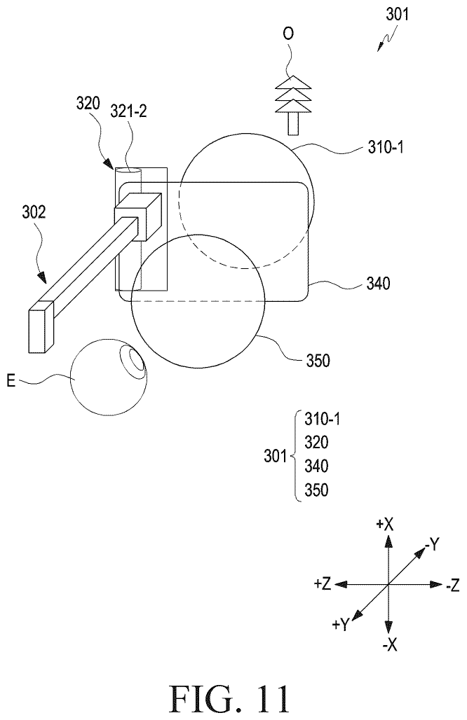

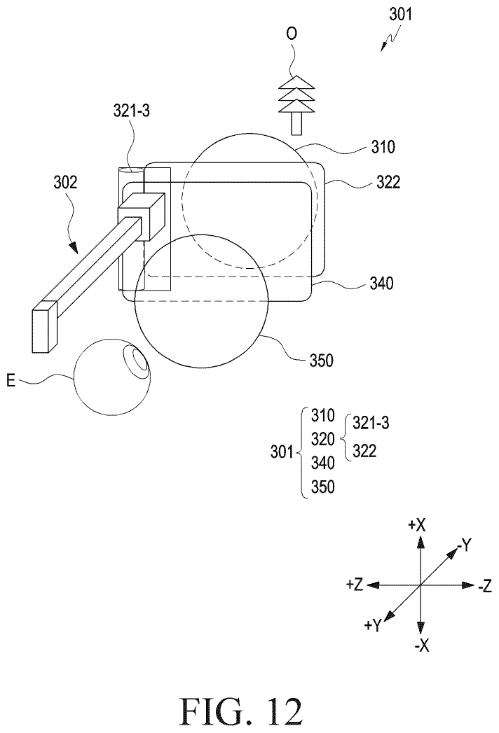

FIG. 9 is a diagram illustrating a side view of an optical structure of a display member of a wearable electronic device according to an embodiment. FIG. 10 is a diagram illustrating a side view of an optical structure of a display member of a wearable electronic device according to an embodiment. FIG. 11 is a perspective view illustrating an optical structure of a display member and an optical output device of a wearable electronic device according to an embodiment. FIG. 12 is a perspective view illustrating an optical structure of a display member and an optical output device of a wearable electronic device according to an embodiment.

The configuration of the display member 301 of FIGS. 9, 10, 11 and 12 (which may be referred to as FIGS. 9 to 12) may be identical or similar in whole or part to the configuration of the configuration of the display member 301 of FIGS. 5 and 6. The correction lens 310, the optical waveguide 340, and the polarization dependent lens 350 of FIGS. 9 to 12 may be referred to as the correction lens 310, the optical waveguide 340, and the polarization dependent lens 350 of FIGS. 5 and 6.

For the components assigned the same reference numerals, the description described above with reference of FIGS. 5 to 8 may be equally applied to the example embodiments of FIGS. 9 to 12, and no duplicate description is given below. The following description of the example embodiments of FIGS. 9 to 12 may focus primarily on differences from the example embodiments of FIGS. 5 and 6.

Referring to FIG. 9, according to an embodiment, the polarizer 322 may be disposed on a surface (e.g., the surface in the −Y direction) of the transparent display 321 facing the correction lens 310. The polarizer 322 may be configured to emit light received from the outside of the wearable electronic device 101 toward the transparent display 321 in the second polarized state. When the polarizer 322 is disposed on the surface (e.g., the surface in the −Y direction) of the transparent display 321 facing the correction lens 310, the optical efficiency of light output from the transparent display assembly 320 or the transparent display 321 may be enhanced as compared to when the polarizer 322 is disposed on the surface (e.g., the surface in the +Y direction) of the transparent display 321 facing the polarization dependent lens 350 (see FIG. 6).

Referring to FIG. 10, according to an embodiment, the transparent display assembly 320 may include a transparent display (or transparent display panel) 321-1 configured to output light (or an image) in the second polarized state. According to an embodiment, the light transmittance of the transparent display 321-1 may be the light efficiency of light (or “image of the real object O”) reflected from the real object O outside the wearable electronic device (e.g., the wearable electronic device 101 of FIGS. 1 to 4).

Referring to FIG. 10, in an embodiment, the correction lens 310-1 of the display member 301 may be a polarization dependent lens. For example, the correction lens 310-1 may function as a lens having a refractive power only for light in a specific polarization state (e.g., the second polarization state), such as the polarization dependent lens 350. According to an embodiment, the correction lens 310-1 may transmit light in the first polarization state as it is and refract light in the second polarization state. In other words, the correction lens 310-1 may be configured to selectively have negative refractive power only for light in the second polarized state. According to an embodiment, the polarization dependent lens 350 may transmit light in the first polarization state as it is and refract light in the second polarization state. According to an embodiment, the polarization dependent lens 350 may be configured to selectively have positive refractive power only for light in the second polarization state.

Referring to FIG. 10, e.g., light (or “image of the real object O”) reflected from the real object O outside the wearable electronic device (e.g., the wearable electronic device 101 of FIGS. 1 to 4) may be incident on the correction lens 310-1 in the random polarization state. The light in the first polarization state of the image of the real object O may be transmitted through the correction lens 310-1 as it is, and the light in the second polarization state may be refracted by the correction lens 310-1 having negative refractive power and distorted (e.g., reduced). The image of the real object O may pass through the transparent display assembly 320 and the optical waveguide 340 or may be transmitted therethrough as it is. In the real image of the object O, the light in the first polarization state may be transmitted through the polarization dependent lens 350 as it is, and the light in the second polarization state may be refracted by the transparent display assembly 320 and the polarization dependent lens 350 having positive refractive power, correcting or canceling the distortion caused by the correction lens 310-1. According to an embodiment, the correction lens 310-1 and the polarization dependent lens 350 may consequently give an effect in which the image of the real object O is transmitted through the display member 301 as it is, and the image of the real object O may be provided without distortion.

Referring to FIGS. 11 and 12, in an embodiment, the transparent display (or transparent display panel) 321-2, 321-3 of the transparent display assembly 320 may be configured to be foldable or rollable (or stretchable). FIGS. 11 and 12 may illustrate a state in which transparent display (or transparent display panel) 321-2, 321-3 is folded or rolled. The state in which the transparent display 321-2 of FIG. 11 is unfolded may be referred to as the transparent display 321-1 of FIG. 10. The state in which the transparent display 321-3 of FIG. 12 is unfolded may be referred to as the transparent display 321 of FIG. 9.

According to an embodiment, when it is not necessary to provide the second image using the transparent display assembly 320, the transparent display 321-2 may be maintained in a folded or rolled state. When it is not necessary to provide the second image using the transparent display assembly 320, the transparent display 321-2 may be allowed not be disposed in the display area of the display member 301, thereby increasing the optical efficiency of light (or “image of the real object O”) reflected from the real object O outside the wearable electronic device (e.g., the wearable electronic device 101 of FIGS. 1 to 4).

FIG. 11 may illustrate an embodiment in which the transparent display 321-1 of FIG. 10 is replaced with a foldable or rollable transparent display 321-2. In the state in which the transparent display 321-2 of FIG. 11 is unfolded, the optical structure of the display member 301 may be the same as the optical structure of the display member 301 of FIG. 10, and the description described above with reference to FIG. 10 may be equally applied to FIG. 11.

Referring to FIG. 11, according to an embodiment, the foldable or rollable transparent display 321-2 may be configured to output light (or an image) in the second polarized state. The display member 301-1 of FIG. 11 may be a polarization dependent lens, and may be referred to as the display member 301-1 of FIG. 10. According to an embodiment, the correction lens 310-1 may transmit light in the first polarization state as it is and refract light in the second polarization state. In other words, the correction lens 310-1 may be configured to selectively have negative refractive power only for light in the second polarized state. According to an embodiment, the light transmittance of the transparent display 321-2 may be the light efficiency of light (or “image of the real object O”) reflected from the real object O outside the wearable electronic device (e.g., the wearable electronic device 101 of FIGS. 1 to 4).

FIG. 12 may illustrate an embodiment in which the transparent display 321 of FIG. 9 is replaced with a foldable or rollable transparent display 321-3. In the state in which the transparent display 321 of FIG. 9 is unfolded, the optical structure of the display member 301 may be the same as the optical structure of the display member 301 of FIG. 12, and the description described above with reference to FIG. 9 may be equally applied to FIG. 12.

Referring to FIG. 12, the transparent display assembly 320 may include a foldable or rollable transparent display 321-3 and a polarizer 322 disposed on one surface of the transparent display 321-3. According to an embodiment, the polarizer 322 may be disposed on one surface of the transparent display 321-3 that faces the correction lens 310. According to an embodiment, the light (or “image of the real object O”) reflected from the real object O outside the wearable electronic device (e.g., the wearable electronic device 101 of FIGS. 1 to 4) transmitted through the correction lens 310 may be polarized in the second polarization state by the polarizer 322 in the random polarization state and may be transferred to the transparent display 321-3 and/or the polarization dependent lens 350.

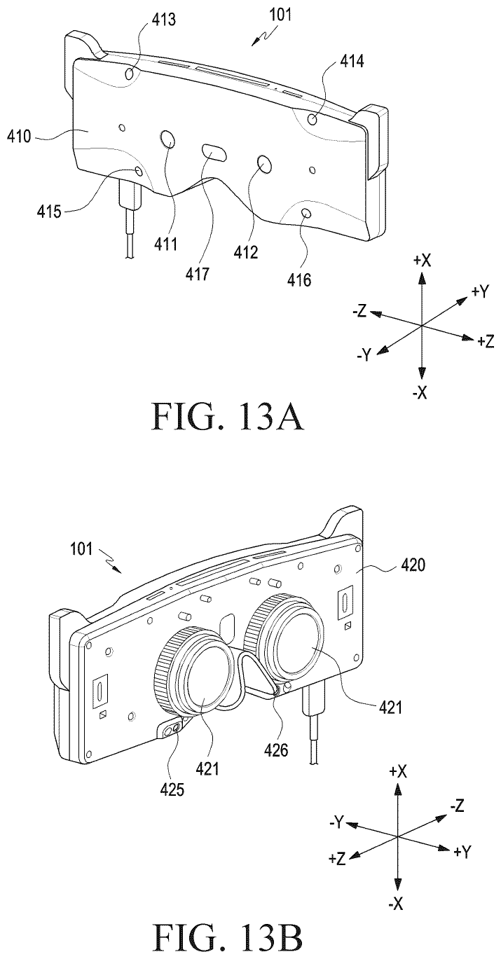

FIG. 13A is a front perspective view illustrating an example wearable electronic device according to an embodiment of the disclosure. FIG. 13B is a rear perspective view illustrating an example wearable electronic device according to an embodiment of the disclosure.

The wearable electronic device 101 of FIGS. 13A and 13B may include a display member (e.g., the display member 201 of FIGS. 2 to 4 and/or the display member 301 of FIGS. 5, 6, 9 to 12) and/or a light output device (e.g., the light output module 211 of FIG. 3 and/or the light output device 302 of FIGS. 5, 11, and 12) according to the example embodiments described above with reference to FIGS. 5 to 12. The description of the example embodiments of FIGS. 5 to 12 may be equally or similarly applied to the example embodiments of FIGS. 13A and 13B.

The display member 421 of FIG. 13B may be referred to as the display member 301 according to the example embodiments of FIGS. 5 to 12.

In an embodiment, the wearable electronic device 101 may be AR glasses or video see-through (VST) type VR glasses. In an embodiment, the VST type VR glasses may capture an external environment using a camera (not shown), and may display the captured image of the surrounding environment (or external environment) of the wearable electronic device 101 to the user through the display member 421 (e.g., a display and/or a lens) together with the VR content. For example, the VR content may be content, such as navigation or data related to a specific object.

Referring to FIGS. 13A and 13B, in an embodiment, camera modules 411, 412, 413, 414, 415, and 416 and/or a depth sensor 417 for obtaining information related to the ambient environment of the wearable electronic device 101 may be disposed on the first surface 410 of the housing.

In an embodiment, the camera modules 411 and 412 may obtain images related to the ambient environment of the wearable electronic device 101.

In an embodiment, the camera modules 413, 414, 415, and 416 may obtain images while the wearable electronic device is worn by the user. The camera modules 413, 414, 415, and 416 may be used for hand detection, tracking, and recognition of the user gesture (e.g., hand motion). The camera modules 413, 414, 415, and 416 may be used for 3 degrees of freedom (DoF) or 6DoF head tracking, location (space or environment) recognition, and/or movement recognition. In an embodiment, the camera modules 411 and 412 may be used for hand detection and tracking and recognition of the user's gesture.

In an embodiment, the depth sensor 417 may be configured to transmit a signal and receive a signal reflected from an object and be used for identifying the distance to the object, such as time of flight (TOF).

According to an embodiment, camera modules 425 and 426 for face recognition and/or a display 421 (and/or lens) may be disposed on the second surface 420 of the housing.

In an embodiment, the face recognition camera modules 425 and 426 adjacent to the display may be used for recognizing the user's face or may recognize and/or track both eyes of the user.

In an embodiment, the display member 421 (e.g., a display and/or a lens) may be disposed on the second surface 420 of the wearable electronic device 101.

The wearable electronic device 101 according to the disclosure may omit at least one of the components shown in FIGS. 13A and 13B or may further include components not shown in the drawings. For example, the wearable electronic device 101 may omit at least one of the camera modules or may include an additional camera module. According to an embodiment, the wearable electronic device 101 may not include some camera modules (e.g., the camera modules 415 and 416) among the plurality of camera modules 413, 414, 415, and 416.

According to an embodiment, the wearable electronic device 101 may further include a wearing member to be worn on the user's body (e.g., head or face). For example, the wearable electronic device 101 may be smart glasses or a head-mounted device (HMD). For example, the wearable electronic device 101 may further include a wearing member such as a strap or a band to be fixed on the user's body part. The wearable electronic device 101 may provide a user experience based on augmented reality, virtual reality, and/or mixed reality while being worn on the user's head.

An embodiment of the disclosure relates to a wearable electronic device including a transparent display assembly configured to provide a first image implementing augmented reality and/or virtual reality using an optical waveguide and an optical output device, and to provide an image and/or a light field image for processing the first image as a high-brightness, high dynamic range (HDR) image in a manually or automatically activated state. According to an embodiment of the disclosure, it is possible to provide a high-brightness, HDR, and/or three-dimensional virtual image or augmented image using a transparent display. The disclosure is not limited to the embodiments mentioned, but may rather be diverse without departing from the spirit and scope of the disclosure. The effects that may be obtained from this disclosure are not limited to the effects mentioned above, and various effects that may be directly or indirectly identified through the disclosure may be provided.

It is apparent to one of ordinary skill in the art that a display member including a transparent display assembly and a wearable electronic device including the same according to various embodiments of the disclosure as described above are not limited to the above-described embodiments and those shown in the drawings, and various changes, modifications, or alterations may be made thereto without departing from the scope of the disclosure.

According to an example embodiment of the disclosure, a wearable electronic device may be provided. The wearable electronic device may comprise: a display member and a light output device. The display member may include: a first lens, a second lens configured to transmit light of a first polarization state and refract light of a second polarization state, an optical waveguide disposed between the first lens and the second lens and configured to receive light output from the light output device and emit the light of the first polarization state toward the second lens, and a transparent display assembly including a transparent display disposed between the first lens and the optical waveguide and configured to output the light of the second polarization state toward the second lens.

According to an example embodiment, the wearable electronic device may be configured to be manually or automatically switchable between a first mode in which the transparent display assembly is deactivated and a second mode in which the transparent display assembly is activated.

According to an example embodiment, the wearable electronic device may further comprise at least one processor; and memory, The memory may store instructions that, when executed by the at least one processor individually, and/or collectively, cause the wearable device to switch the wearable electronic device from the first mode to the second mode based on information about a first image based on the light emitted from the optical waveguide.

According to an example embodiment, the display member may be configured to provide an image in which a first image based on the light emitted from the optical waveguide and a second image based on light emitted from the transparent display overlap each other.

According to an example embodiment, the optical waveguide may be transparent. Light received through the first lens from an outside of the wearable electronic device and light output from the transparent display assembly may be incident on the second lens without being incident to an input end of the optical waveguide.

According to an example embodiment, the optical waveguide may be configured to emit the light of the first polarization state toward the second lens.

According to an example embodiment, the optical waveguide may be configured to emit the light of the second polarization state toward the second lens.

According to an example embodiment, the transparent display assembly may include a transparent display, and a polarizer disposed on a surface of the transparent display facing the first lens or a surface of the transparent display facing the second lens.

According to an example embodiment, the transparent display assembly may comprise a transparent display configured to output the light of the second polarization state.

According to an example embodiment, the first lens may be disposed and configured to receive light from an outside of the wearable electronic device, and the second lens may be disposed to face a user's eye.

According to an example embodiment, the display member may include a first surface facing an outside of the wearable electronic device and a second surface facing in a direction opposite to the first surface.

According to an example embodiment, the first lens may be closer to the first surface of the display member than to the second surface of the display member, and the second lens may be closer to the second surface of the display member than to the first surface of the display member.

According to an example embodiment, at least a portion of light received from an outside of the wearable electronic device may be transmitted through the first lens and may be polarized into the second polarization state by the transparent display assembly and emitted toward the second lens.

According to an example embodiment, the first lens may have negative refractive power. According to an example embodiment, the second lens may be configured to selectively have positive refractive power for the light of the second polarization state.

According to an example embodiment, the transparent display assembly may comprise a foldable or rollable transparent display.

According to an example embodiment, a wearable electronic device may be provided. The wearable electronic device may comprise: a display member and a light output device. The display member may include: a first lens, a second lens, an optical waveguide disposed between the first lens and the second lens and configured to receive light output from the light output device and emit the light of the first polarization state toward the second lens, and a transparent display assembly including a transparent display disposed between the first lens and the optical waveguide and configured to output light toward the second lens. The wearable electronic device may be configured to be manually or automatically switchable between a first mode in which the transparent display assembly is deactivated and a second mode in which the transparent display assembly is activated.

According to an example embodiment, the second lens may be configured to transmit light of a first polarization state and refract light of a second polarization state.

According to an example embodiment, the optical waveguide may be configured to emit the light of the first polarization state toward the second lens. The transparent display assembly may be configured to output the light of the second polarization state toward the second lens.

According to an example embodiment, the optical waveguide may be configured to emit the light of the second polarization state toward the second lens. The transparent display assembly may be configured to output the light of the second polarization state toward the second lens.

According to an example embodiment, the wearable electronic device may further comprise at least one processor, and memory, The memory may store instructions that, when executed by the at least one processor individually, and/or collectively, cause the wearable device to switch the wearable electronic device from the first mode to the second mode based on information about a first image based on the light emitted from the optical waveguide.

While the disclosure has been illustrated and described with reference to various example embodiments thereof, it should be appreciated that the various example embodiments are intended to be illustrative, not limiting. It will be apparent to one skilled in the art that various changes in form and detail may be made without departing from the full scope of the disclosure, including the appended claims and their equivalents. It will also be understood that any of the embodiment(s) described herein may be used in conjunction with any other embodiment(s) described herein.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable electronic device comprising:
a display member; and
a light output device including a polarizer,
wherein the display member includes:
a first lens;
a second lens configured to transmit light of a first polarization state and refract light of a second polarization state;
an optical waveguide disposed between the first lens and the second lens and configured to receive light output from the light output device and emit the light of the first polarization state toward the second lens; and
a transparent display assembly including a transparent display disposed between the first lens and the optical waveguide and configured to output the light of the second polarization state toward the second lens.

2. The wearable electronic device of claim 1,
wherein the wearable electronic device is configured to be manually or automatically switchable between a first mode in which the transparent display assembly is deactivated and a second mode in which the transparent display assembly is activated.

3. The wearable electronic device of claim 2, further comprising
at least one processor, and
memory,
wherein the memory stores instructions that, when executed by the at least one processor individually and/or collectively, cause the wearable device to switch the wearable electronic device from the first mode to the second mode based on information about a first image based on the light emitted from the optical waveguide.

4. The wearable electronic device of claim 1,
wherein the display member is configured to provide an image in which a first image based on the light emitted from the optical waveguide and a second image based on light emitted from the transparent display overlap each other.

5. The wearable electronic device of claim 1,
wherein the optical waveguide is transparent, and
wherein light received through the first lens from an outside of the wearable electronic device and light output from the transparent display assembly are configured to be incident on the second lens without being incident to an input end of the optical waveguide.

6. The wearable electronic device of claim 1,
wherein the optical waveguide is configured to emit the light of the first polarization state toward the second lens.

7. The wearable electronic device of claim 1,
wherein the optical waveguide is configured to emit the light of the second polarization state toward the second lens.

8. The wearable electronic device of claim 1,
wherein the transparent display assembly comprises: a transparent display; and
a polarizer disposed on a surface of the transparent display facing the first lens or a surface of the transparent display facing the second lens.

9. The wearable electronic device of claim 1,
wherein the transparent display assembly comprises a transparent display configured to output the light of the second polarization state.

10. The wearable electronic device of claim 1,
wherein the first lens is disposed and configured to receive light from an outside of the wearable electronic device, and the second lens is disposed to face a user's eye.

11. The wearable electronic device of claim 1,
wherein the display member includes a first surface facing an outside of the wearable electronic device and a second surface facing in a direction opposite to the first surface.

12. The wearable electronic device of claim 11,
wherein the first lens is closer to the first surface of the display member than to the second surface of the display member, and the second lens is closer to the second surface of the display member than to the first surface of the display member.

13. The wearable electronic device of claim 1,
wherein the wearable electronic device is configured to transmit at least a portion of light received from an outside of the wearable electronic device through the first lens and is polarized into the second polarization state by the transparent display assembly and emitted toward the second lens.

14. The wearable electronic device of claim 1,
wherein the first lens has negative refractive power, and
wherein the second lens is configured to selectively have positive refractive power for the light of the second polarization state.

15. The wearable electronic device of claim 1,
wherein the transparent display assembly comprises a foldable or rollable transparent display.

16. A wearable electronic device comprising:
a display member; and
a light output device including a polarizer,
wherein the display member includes:
a first lens;
a second lens;
an optical waveguide disposed between the first lens and the second lens and configured to receive light output from the light output device and emit the light of the first polarization state toward the second lens; and
a transparent display assembly including a transparent display disposed between the first lens and the optical waveguide and configured to output light toward the second lens, and
wherein the wearable electronic device is configured to be manually or automatically switchable between a first mode in which the transparent display assembly is deactivated and a second mode in which the transparent display assembly is activated.

17. The wearable electronic device of claim 16,
wherein the second lens is configured to transmit light of a first polarization state and refract light of a second polarization state.

18. The wearable electronic device of claim 17,
wherein the optical waveguide is configured to emit the light of the first polarization state toward the second lens, and
wherein the transparent display assembly is configured to output the light of the second polarization state toward the second lens.

19. The wearable electronic device of claim 17,
wherein the optical waveguide is configured to emit the light of the second polarization state toward the second lens, and
wherein the transparent display assembly is configured to output the light of the second polarization state toward the second lens.

20. The wearable electronic device of claim 16, further comprising at least one processor, and
memory;
wherein the memory stores instructions that, when executed by the at least one processor individually and/or collectively, cause the wearable device to switch the wearable electronic device from the first mode to the second mode based on information about a first image based on the light emitted from the optical waveguide.
